(19) United States
(12) Patent Application Publication
(10) Pub. No.: US 2009/0213777 A1
(43) Pub. Date: Aug. 27, 2009

(54) DISTRIBUTION APPARATUS AND RECEIVING APPARATUS FOR REPRODUCING PREDETERMINED CONTENTS

(75) Inventors: Kazuya Ogawa, Mizuho-City (JP); Hiroshi Takemura, Aisai-City (JP); Yuichi Kanai, Ichinomiya-City (JP); Yoko Tanaka, Mizuho-City (JP); Haoming Shen, Ichinomiya-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/394,655

(22) Filed: Feb. 27, 2009

(30) Foreign Application Priority Data
Feb. 27, 2008 (JP) 2008-046576
Feb. 27, 2008 (JP) 2008-046580

(51) Int. Cl. H04H 20/71

(52) U.S. Cl. 370/312

(57) ABSTRACT

A content receiver receives content data distributed repeatedly from a distribution station. The content data are stored in a content storage. A reproduction processing unit sequentially reproduces parts of the content data stored in the storage corresponding to content data received by the content receiver. A content management unit monitors the degree of completion of the content data stored. When the monitored degree of completion becomes a preset level or above, a connection processing unit disconnects connection to the distribution station. After the connection has been disconnected, an identifier receiver receives reproduction information informed from the distribution station. The reproduction processing unit reproduces the content data according to the reproduction information.

### CROSS-REFERENCE TO RELATED APPLICATIONS

This application is based upon and claims the benefit of priority from the prior Japanese Patent Applications No. 2008-046580, filed Feb. 27, 2008, and Japanese Patent Application No. 2008-046576, filed Feb. 27, 2008, the entire contents of which are incorporated herein by reference.

### BACKGROUND OF THE INVENTION

1. Field of the Invention

The present invention relates to a distribution technology and a receiving technology, in particular, to a distribution apparatus and a receiving apparatus for reproducing predetermined contents.

2. Description of the Related Art

When the same content data are to be reproduced by a plurality of terminal apparatuses, the terminal apparatuses need to be synchronized among them. A technique is considered where the terminal apparatuses that are receiving multicast distribution data are synchronized.

When the same content data is to be reproduced among a plurality of terminal apparatuses, the content data needs to be reproduced at the same timing among the terminal apparatuses. A technique is under consideration where the start time of reproduction is appended within a file and the reproduction is started at the timing thereof.

In this patent specification, terms “receiving apparatus”, “terminal apparatus”, and “receiving terminal” are used interchangeably.

However, there are cases where receiving terminals do not receive the contents and do not establish connection with a distribution source. For example, when, in a system where the contents are repeatedly distributed by multicast, the received contents data are stored and their data are reproduced, the contents data received a plurality of times are stored and therefore there is no need to receive data any longer. As a result, the connection to the distribution source is no longer required. In such a case, however, it is still necessary that one receiving terminal and the other receiving terminals be synchronized. Since in this case the connection to the distribution source is disconnected, such a normal distribution as one using multicast or unicast cannot be used then.

When a file has been distributed, there are cases where the timing of its reproduction is unknown. For instance, when the contents are distributed from a distribution station to receiving terminals by using a multicast scheme, the loss of packets occurs in most cases. In particular, when the contents are distributed via wireless LAN (Local Area Network), a large number of packets are lost depending on a radio wave condition. Under such a circumstance, even though an error correcting technique is implemented, it is not always possible to reproduce the moving image contents with a sufficiently durable quality for the viewing. Thus, if comparatively short contents such as advertisement are distributed repeatedly, a receiving terminal can merge the data received using the multicast and the data which have been stored up to that point in time. As a result, the receiving terminal can acquire more accurate content data. In other words, the contents become reproducible by receiving them by multicast distribution a plurality of times.

On the other hand, when a plurality of receiving terminals receive and reproduce the same contents, there are occasions where it is preferred that the timing at which the contents are reproduced by each of the plurality of receiving terminals be synchronized. For instance, consider a case where a plurality of receiving terminals are installed in a certain limited place and the presence of the contents is brought to the attention of users. If the reproduction thereof is started with the reproducible timing, the reproducible timing may differ for each receiving terminal due to a difference in radio wave condition of a place where each receiving terminal is installed and the capacity of each receiving terminal. Thus the same contents may be reproduced with different timings.

### SUMMARY OF THE INVENTION

The present invention has been made under the foregoing circumstances, and one advantage thereof resides in providing a technique by which timings of starting the reproduction of content data are synchronized among a plurality of receiving terminals which have not yet been connected to a distribution station. Another advantage thereof resides in providing a technique by which the timing of starting the reproduction thereof at each receiving terminal is synchronized when the content data are distributed by multicast to a plurality of receiving terminals.

In order to resolve the above problems, a distribution apparatus according to one embodiment of the present invention comprises: a first transmitter which distributes repeatedly content data to a first receiving apparatus; and a second transmitter which broadcasts reproduction information for the content data distributed by the first transmitter wherein the reproduction information indicates a part of the content data to be reproduced by a second receiving apparatus.

Another embodiment of the present invention relates to a receiving apparatus. This apparatus comprises: a first receiver which receives content data distributed repeatedly from a distribution apparatus; a storage which stores the content data received by the first receiver; a second receiver which receives reproduction information, broadcasted from the distribution apparatus, indicating a part of the content data to be reproduced; and a reproduction unit which reproduces the content data when the content data are received by the first receiver or which reproduces the content data stored in the storage according to the reproduction information received by the second receiver when the content data are not received by the first receiver.

Still another embodiment of the present invention relates also to a distribution apparatus. This apparatus comprises: a first transmitter which distributes content data to a plurality of receiving apparatuses; and a second transmitter which transmits an instruction used to reproduce the content data after the content data have been distributed from the first transmitter.

Still another embodiment of the present invention relates also to a receiving apparatus. This apparatus comprises: a first receiver which receives content data from the distribution apparatus; a second receiver which receives the reproduction instruction for the content data transmitted from the distribution apparatus; and a reproduction unit which reproduces the content data received by the first receiver according to the reproduction instruction received by the second receiver.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates a general structure of a communication system according to an exemplary embodiment of the present invention;

FIG. 2 illustrates a detailed structure of the communication system shown in FIG. 1;

FIG. 3 is a flowchart showing a reproduction procedure performed by a receiving terminal shown in FIG. 2;

FIG. 4 illustrates a general structure of a communication system according to a modification to an exemplary embodiment of the present invention;

FIG. 5 illustrates a detailed structure of the communication system shown in FIG. 4;

FIG. 6 is a sequential diagram showing a distribution procedure performed by a communication system shown in FIG. 5; and

FIG. 7 is a flowchart showing a distribution procedure performed by a distribution station shown in FIG. 5; and

FIG. 8 is a flowchart showing a reproduction procedure performed by a receiving terminal shown in FIG. 5.

### DETAILED DESCRIPTION OF THE INVENTION

The invention will now be described by reference to the preferred embodiments. This does not intend to limit the scope of the present invention, but to exemplify the invention.

The present invention will be outlined hereinbelow before it is described in detail. Exemplary embodiments of the present invention relate to a communication system comprised of a distribution station and a plurality of receiving terminals. Here, the distribution station and the plurality of receiving terminals are connected via wireless LAN, for instance. The distribution station stores content data beforehand and distributes repeatedly the content data to the plurality of receiving terminals using multicast distribution. Each receiving terminal combines the received content data with those which have already been received, and thereby updates the content data and stores them. Each receiving terminal reproduces the thus stored content data sequentially starting from parts corresponding to the received content data. If the degree of completion of the stored content data is high enough, the receiving terminal need not receive the content data any longer and therefore the connection between the receiving terminal and the distribution station can be disconnected. Even after the connection between the receiving terminal and the distribution station has been disconnected, the communication system according to an exemplary embodiment performs the following processing to synchronize the timing of reproduction in each of the plurality of receiving terminals.

The distribution station according to an exemplary embodiment of the present invention has information, on the time at which a header part of the content data is to be reproduced, contained in a beacon (SSID) receivable even by a receiving terminal which has not yet established connection with this distribution station. If a receiving terminal has not yet established connection with the distribution station, the receiving terminal will receive the beacon from the distribution station and acquire the information on the time at which a header part of the content data is to be reproduced. The receiving terminal reproduces the content data according to the information acquired. Here, the information on the time at which a header part of the content data is to be reproduced is so generated as to synchronize the content data distributed by multicast. Accordingly, the reproduction timing is synchronized among a plurality of receiving terminals regardless of whether or not they are connected to the distribution station. The beacon (SSID) varies as the reproduction continues. And when a connection is established using this SSID, the connection is disconnected in a short while. Thus, connection refusal is set to this SSID.

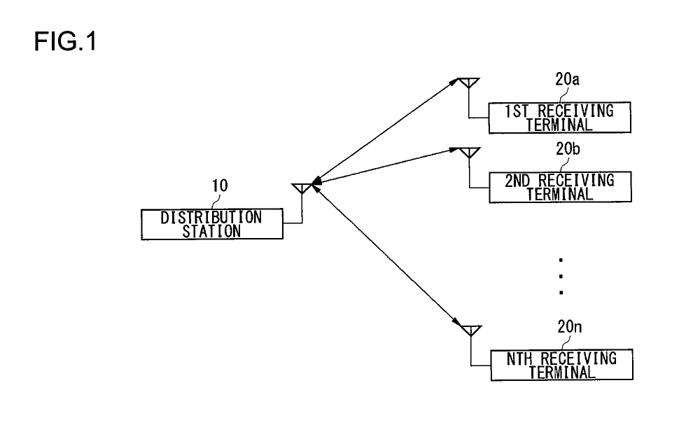

FIG. 1 illustrates a general structure of a communication system 30 according to an exemplary embodiment of the present invention. The communication system 30 includes a distribution station 10, a first receiving terminal 20a, a second receiving terminal 20b, . . . , an Nth receiving terminal 20n, which are generically referred to as “receiving terminal 20”.

The distribution station 10 functions as a wireless LAN base station apparatus and also has a storage for storing the content data. With this structure, the distribution station 10 repeatedly distributes the content data by multicast. Accordingly, assume that the length of content data is relatively short. Since a known art may be used for the coding and multicast applied to the content data, the description thereof is omitted here. The distribution station 10 distributes the content data by multicast and at the same time sends out beacon periodically the same way as a normal wireless LAN base station apparatus does. Also, at predetermined timing the distribution station 10 has the beacon contain SSID containing reproduction information (hereinafter referred to as “notifying identifier” also) indicating the timing with which the content data are reproduced.

The receiving terminal 20 receives the content data that the distribution station 10 has distributed by multicast, and reproduces the received content data. Since the content data are distributed by multicast, no retransmission control is generally performed. Accordingly, when the receiving terminal 20 receives the content data once, it is not always the case that all of the content data have been accurately received. In particular, if the content data are distributed via wireless LAN, the packet loss may occur and therefore there will be cases where the content data are not reproduced by the receiving terminal with sufficient quality. Thus, the receiving terminal 20 stores the content data distributed repeatedly from the distribution station 10, and compares and verifies them against each other. As a result, the accuracy of the content data stored in the receiving terminal 20 is raised and the content data can be reproduced with sufficient quality.

The receiving terminal 20 reproduces the generated content data and, at the same time, stores again said content data. Every time the content data distributed from the distribution station 10 are repeated, the receiving terminal 20 repeats the above-described processing, so that the accuracy of content data is enhanced. Finally, even when the stored content data only are reproduced, they can be reproduced with enough accuracy. Accordingly, the receiving terminal 20 no longer needs to receive content data distributed from the distribution station 10. Thus, the receiving terminal 20 disconnects the connection between the receiving terminal 20 and the distribution station 10. In other words, the operation that a receiving terminal 20 participating in the multicast distribution disconnects the connection between the receiving terminal 20 and the distribution station 10 corresponds to notifying the distribution station 10 that the storage of the content data has been completed. It is assumed here that the receiving terminal 20 transmits a disconnection request to the distribution station 10 when the connection is to be disconnected.

Nevertheless, when the connection is disconnected, the receiving terminal 20 cannot acquire the timings at which content data are distributed. In this case, if there are a plurality of receiving terminals 20 and these receiving terminals 20 receive and reproduce the same content data, the reproduction timing may differ among the plurality of receiving terminals 20 even though the same content data are being reproduced. The distribution station 10 conveys the reproduction timing of content data to the receiving terminals 20 which are not connected to the distribution station 10 in a manner such that notifying identifiers are contained in the beacon. The receiving terminals 20 reproduce the stored content data, based on the notifying identifiers contained in the beacon.

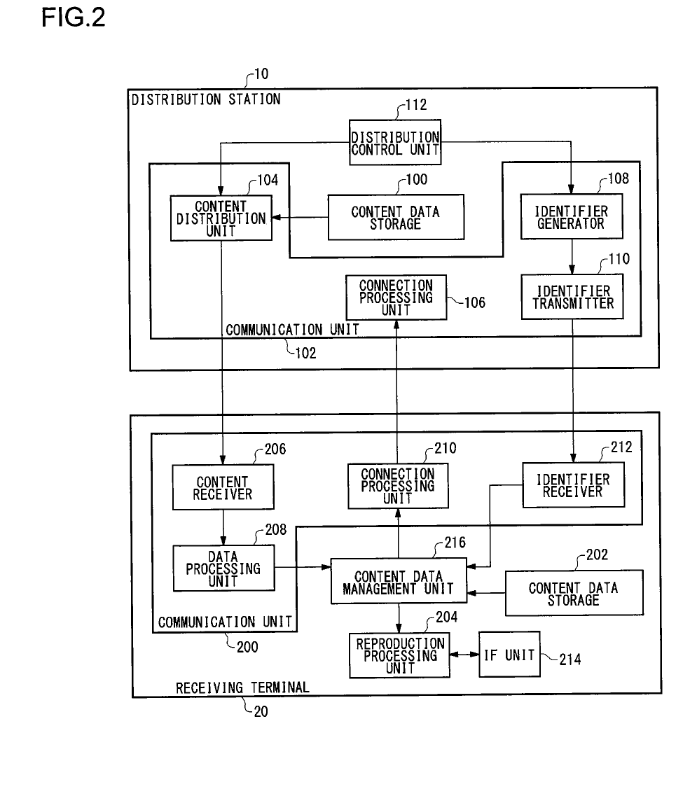

FIG. 2 illustrates a structure of the communication system 30. The distribution station 10 includes a content data storage 100, a communication unit 102, and a distribution control unit 112. The communication unit 102 includes a content distribution unit 104, an identifier generator 108, an identifier transmitter 110, and a connection processing unit 106. The receiving terminal 20 includes a communication unit 200, a content data storage 202, a reproduction processing unit 204, an IF unit 214, and a content data management unit 216. The communication unit 200 includes a content receiver 206, a data processing unit 208, an identifier receiver 212, and a connection processing unit 210.

The content data storage 100 stores content data which are to be distributed from the distribution station 10. Content IDs used to identify the content data and packet numbers assigned to their packets of the content data are contained in the content data. The content distribution unit 104 reads out the content data stored in the content data storage 100 according to a request transmitted from the distribution control unit 112. The content distribution unit 104 distributes repeatedly the read content data to the receiving terminal 20 by multicast. It is assumed herein that the connection has been established between the distribution station 10 and the receiving terminal 20 and the multicast distribution has already been set.

The distribution control unit 112 manages the content data to be distributed by the distribution station 10 and reproduction information indicating the addresses where said content data are to be reproduced. More specifically, the distribution control unit 112 generates the reproduction information indicating a part of the content data that the receiving terminal 20 shall be reproducing at the present moment, based on a distribution part of the content data distributed by the content distribution unit 104. That is, the reproduction information is so generated as to be compatible with the content data reproduced by the content distribution unit 104. The distribution control unit 112 requests the content distribution unit 104 to distribute contents to be distributed, based on the reproduction information managed by the distribution control unit 112 itself. Also, the distribution control unit 112 requests the identifier generator 108 to generate notifying identifiers based on the reproduction information.

The connection processing unit 106 performs processing for establishing and disconnecting connection with the receiving terminal 20. Here, as described above, when the receiving terminal 20 goes into a state where the receiving of the multicast distribution is no longer required, namely a state where the distribution of content data has been completed, the receiving terminal 20 disconnects the connection. When the connection processing unit 106 detects that the content distribution unit 104 has been disconnected from the receiving terminal 20 after the content distribution unit 104 had transmitted the content data, the connection processing unit 106 determines that the content data are reproducible without the multicast distribution.

The identifier generator 108 generates a notifying identifier that contains reproduction information, based on a request from the distribution control unit 112. The notifying identifier is an identifier used to convey the reproduction information to a receiving terminal 20 that has not established connection with the distribution station 10 and is set separately from an identifier conveyed to establish connection with the distribution station 10 (hereinafter this identifier will be referred to as “connecting identifier”). The notifying identifier contains a content ID and information on time when the reproduction of the content is to start. Assume herein that a network time protocol (NTP) is used as a protocol for adjusting the clock in the communication system 30 and the time has already been synchronized among a plurality of receiving terminals 20.

If the distribution station 10 performs a plurality of multicast distributions, the identifier generator 108 may have a connecting identifier contain stream IDs used to identify streams and a reproduction start instruction on each stream. The identifier generator 108 outputs the notifying identifier generated to the identifier transmitter 110. The identifier transmitter 110 transmits the notifying identifier generated by the identifier generator 108, as beacon. That is, the identifier transmitter 110 broadcasts the reproduction information. Note that the identifier transmitter 110 may also transmit the connecting identifier which has been set separately from the notifying identifier.

The content receiver 206 receives content data repeatedly distributed by multicast from the distribution station 10. The content receiver 206 outputs the received content data to the data processing unit 208. The data processing unit 208 processes the content data received by the content receiver 206. More specifically, the data processing unit 208 performs error processing on the content data and outputs the content data obtained as a result thereof to the content data management unit 216.

The content data management unit 216 manages the content data processed by the data processing unit 208. More specifically, the content data management unit 216 verifies if any content data stored in the content data storage 202 bears the same content ID and packet number as those contained in the content data processed by the data processing unit 208 or not. If no such content data is stored in the content data storage 202, said content data will be stored in the content data storage 202. Also, the content data management unit 216 reads out content data to be reproduced by the reproduction processing unit 204, from the content data storage 202, and outputs the content data to the reproduction processing unit 204.

In so doing, the content data management unit 216 updates the content data by combining the content data from the data processing unit 208 with the content data which has already been stored in the content data storage 202. The content data management unit 216 stores the updated content data in the content data storage unit 202. If connection has been established with the distribution station 10, namely the multicast distribution is being received, the content data to be reproduced by the reproduction processing unit 204 will be determined based on the content data outputted from the data processing unit 208. On the other hand, after the connection has been disconnected, the content data are determined based on the reproduction information outputted from the identifier receiver 212.

Further, the content data management unit 216 monitors the degree of completion of the content data stored in the content data storage 202. In other words, the content data management unit 216 determines how close the content data stored in the content data storage 202 is to the content data stored in the content data storage 100. When the degree of completion becomes greater than or equal to a preset level, the content data management unit 216 will request the connection processing unit 210 to disconnect the connection to the distribution station 10.

The content data storage 202 stores the content data received by the content receiver 206. The content data stored in the content data storage 202 is managed by the content data management unit 216. The reproduction processing unit 204 reproduces the content data acquired from the content data management unit 216. This corresponds to the sequential reproduction of parts, corresponding to the received content data of those stored in the content data storage 202, while multicast distribution is received. The IF unit 214 is an interface with a user and is constituted by buttons, a display, a speaker and so forth. The display displays images out of the content data reproduced by the reproduction processing unit 204. The speaker outputs audio out of the content data reproduced by the reproduction processing unit 204. The buttons receive instructions from the user.

The connection processing unit 210 establishes and disconnects connection with the distribution station 10, based on a request from the content data management unit 216. For example, when the degree of completion monitored by the content data management unit 216 becomes greater than or equal to the preset level, the connection processing unit 210 disconnects the connection to the distribution station 10. Here, the connection processing unit 210 sends a disconnection request to the distribution station 10.

The identifier receiver 212 receives a notifying identifier distributed from the distribution station 10, and extracts reproduction information contained in the received identifier. In other words, after the connection has been disconnected by the connection processing unit 210, the identifier receiver 212 receives the reproduction information, notified from the distribution station 10, which indicates a part of the content data to be reproduced at the present moment. The identifier receiver 212 outputs the extracted reproduction information to the content data management unit 216. Note that the identifier receiver 212 may receive a connecting identifier, which differs from the notifying identifier, transmitted from the distribution station 10 as beacon. In so doing, the connecting identifier thus acquired is outputted to the connection processing unit 210 and is used when connection is established between the connection processing unit 210 and the distribution station 10. This connecting identifier may be stored beforehand in the receiving terminal 20 instead of being transmitted as beacon from the distribution station 10. As a result, a receiving terminal 20 cannot be connected to the distribution station 10 unless it stores the connecting identifier therein, thereby enhancing the safety of the receiving terminal 20.

After the connection between the connection processing unit 210 and the distribution station 10 has been disconnected, the reproduction processing unit 204 reproduces content data stored in the content data storage 202, according to the reproduction information received by the identifier receiver 212. The reproduction information and the content data are inputted to the reproduction processing unit 204 via the content data management unit 216. When the reproduction processing unit 204 reproduces the content data according to the reproduction information after the connection processing unit 210 has disconnected the connection to the distribution station 10, there may be cases where the content data to be reproduced is not stored in the content data storage 202. In such a case, the content data management unit 216 instructs the connection processing unit 210 to establish connection with the distribution station 10. According to the instruction from the content data management unit 216, the connection processing unit 210 establishes connection with the distribution station 10. After connection with the distribution station 10 has been established by the connection processing unit 210, the content receiver 206 receives again the content data distributed repeatedly from the content distribution unit 104 in the distribution station 10. The processing after this is similar to that described above, so that the description thereof is omitted here.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

An operation of the communication system 30 as structured above will now be described briefly. The content distribution unit 104 distributes content data. The distribution control unit 112 generates successively the reproduction information in such a manner that the reproduction information is compatible with the content data distributed from the content distribution unit 104. At the same time, the identifier generator 108 generates a notifying identifier based on each reproduction information. The identifier transmitter 110 transmits the thus generated notifying identifier as beacon.

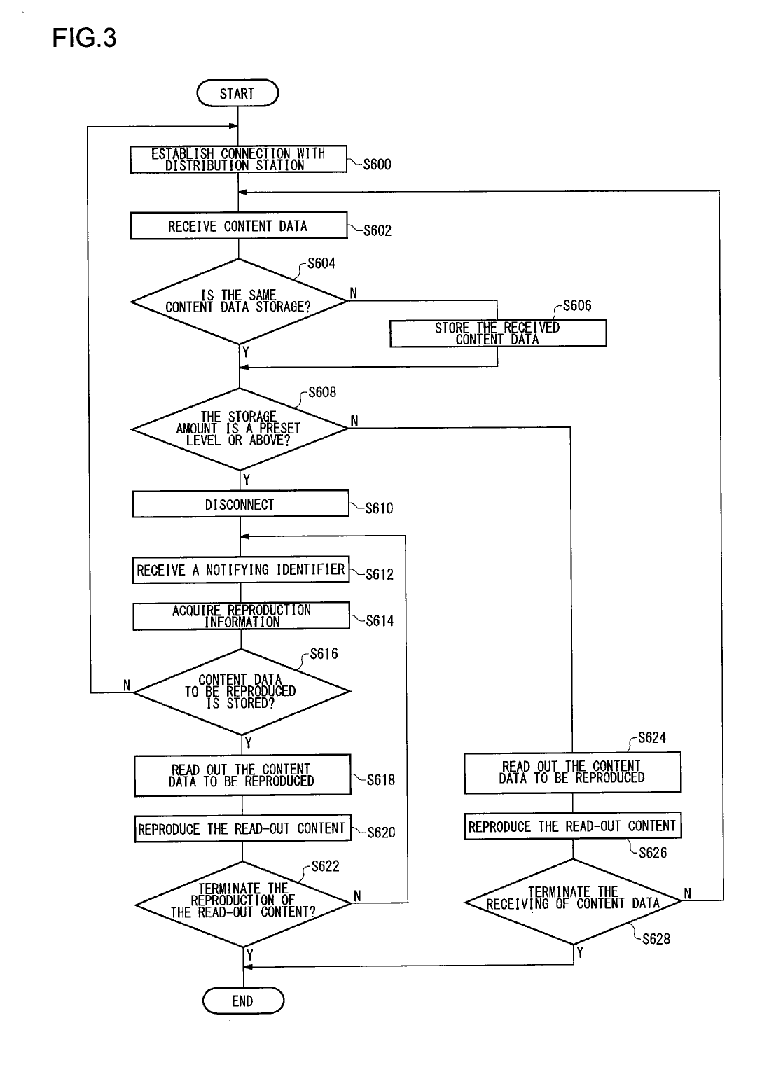

FIG. 3 is a flowchart showing a reproduction procedure performed by a receiving terminal 20. The receiving terminal 20 establishes connection with a distribution station (S600). The content receiver 206 receives content data distributed from the distribution station 10 (S602). The content data management unit 216 checks to see if any content data having the same ID and packet number as those of the received content data are stored in the content data storage 202 or not (S604). If not stored (N of S604), the content data management unit 216 will have the content data storage 202 store the received content data (S606). If, on the other hand, the same content data are stored in the content data storage 202 (Y of S604), Step S606 will be skipped.

The content data management unit 216 determines if the amount of content data stored in the content data storage 202 becomes greater than or equal to a preset level or not (S608). If the amount of the content data stored is not the preset level or above (N of S608), the content data management unit 216 will read out the content data to be reproduced, from the content data storage 202 (S624) and the reproduction processing unit 204 will reproduce the read-out content data (S626). If the receiving of the content data has not been completed (N of S628), return to Step S602. If the receiving of the content data has been completed (Y of S628), the processing will be terminated.

If, on the other hand, the amount of the content data stored is the preset level or above (Y of S608), the connection processing unit 210 will disconnect the connection to the distribution station 10 (S610). The identifier receiver 212 receives a notifying identifier transmitted as beacon (S612). The identifier receiver 212 acquires reproduction information from the notifying identifier received (S614). The content data management unit 216 determines whether or not the content data storage 202 stores content data to be reproduced next, according to the reproduction information (S616). If not stored (N of S616), return to Step S600. If, on the other hand, the content data storage 202 stores the content data to be reproduced next (Y of S616), the content data management unit 216 will read out the content data to be reproduced, from the content data storage 202 (S618). The reproduction processing unit 204 reproduces the read-out content data (S620). If the reproduction of the content data is not to be terminated (N of S622), return to Step S612. If the reproduction of the content data is to be terminated (Y of S622), the processing will be terminated.

By employing this exemplary embodiment, the reproduction is performed by a receiving terminal executing the multicast distribution, based on the content data, whereas the reproduction is performed by a receiving terminal not executing the multicast distribution, based on the reproduction information. As a result, the reproduction start timing can be synchronized. Also, the reproduction information is generated in such a manner that it is compatible with the content data distributed from the content distribution unit 104. Hence, the reproduction start timings of content data in a plurality of receiving terminals can be synchronized. Since the content data are reproduced based on the content data or reproduction information, the reproduction start timing in each receiving terminal can be synchronized even though the content is distributed to a plurality of receiving terminals by multicast. If the content data are not stored, the connection is established again even after the connection had been disconnected. Thus, the reproduction of the content data can be assured. Since the content data which has been repeatedly distributed is stored, the quality of content data can be enhanced.

A description is now given of a modification to the present exemplary embodiment. This modification relates to a communication system comprised of a distribution station and a plurality of receiving terminals. Here, the distribution station and the plurality of receiving terminals are connected via wireless LAN, for instance. The distribution station stores content data beforehand and distributes repeatedly the content data to the plurality of receiving terminals using multicast distribution. Each receiving terminal stores the received content and then reproduces the content stored. The communication system according to the present modification performs the following processing to synchronize the timing of reproduction in each of the plurality of receiving terminals.

The distribution station determines if all of receiving terminals, to which content data are to be distributed by multicast, become capable of reproducing the content data or not. If it is determined that they are capable, the distribution station will instruct all of receiving terminals to reproduce the content data. In order to grasp the situation that a receiving terminal has become capable of reproducing the content data, the receiving terminal disconnects the connection to the distribution station when the receiving terminal has become capable of reproducing the content data. Here, when the receiving terminal is capable of reproducing the content data, there is no need for the receiving terminal to receive content data any longer. As a result, the connection to the distribution station can be disconnected. When all of receiving terminals, to which content data are to be distributed, have disconnected their connections, the distribution station instructs them to reproduce the content data. In so doing, the distribution station conveys an instruction content using the beacon (SSID) receivable even by a receiving terminal which has not yet established connection with the distribution station. This beacon is transmitted temporarily. And when the receiving terminal establishes connection after receiving this beacon, the connection is disconnected in a short while. Thus, connection refusal is set to this beacon.

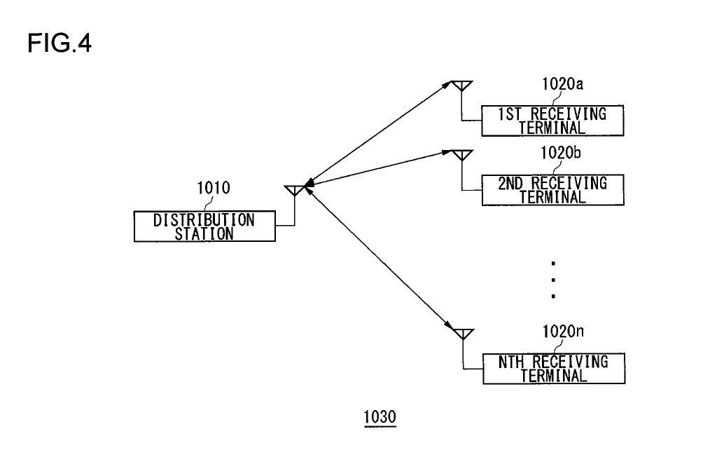

FIG. 4 illustrates a general structure of a communication system 1030 according to a modification to the exemplary embodiment. The communication system 1030 includes a distribution station 1010, a first receiving terminal 1020a, a second receiving terminal 1020b, . . . , an Nth receiving terminal 1020n, which are generically referred to as “receiving terminal 1020”.

The distribution station 1010 functions as a wireless LAN base station apparatus and also has a storage for storing the content data. With this structure, the distribution station 1010 repeatedly distributes the content data by multicast. Accordingly, assume that the length of content data is relatively short. Since a known art may be used for the coding and multicast applied to the content data, the description thereof is omitted here. The distribution station 1010 distributes the content data by multicast and at the same time sends out beacon periodically the same way as a normal wireless LAN base station apparatus does. Also, at predetermined timing the distribution station 1010 has the beacon contain SSID containing reproduction information (hereinafter referred to as “reproduction instruction information” also) used to instruct the start of reproduction of the distributed content data.

The receiving terminal 1020 receives the content data that the distribution station 1010 has distributed by multicast, and reproduces the received content data. Since the content data are distributed by multicast, no retransmission control is generally performed. Accordingly, when the receiving terminal 1020 receives the content data once, it is not always the case that all of the content data have been accurately received. In particular, if the content data are distributed via wireless LAN, the packet loss may occur and therefore there will be cases where the content data are not reproduced by the receiving terminal with sufficient quality. Thus, the receiving terminal 1020 stores the content data distributed repeatedly from the distribution station 1010, and compares and verifies them against each other. At this stage, the receiving terminal 1020 does not reproduce the content data.

As a result, the accuracy of the content data stored in the receiving terminal 1020 is raised and the content data can be reproduced with sufficient quality. After the accuracy of content data has reached a reproducible level in the receiving terminal 1020, the receiving terminal 1020 no longer needs to receive the contents distributed from the distribution station 1010. Thus, the receiving terminal 1020 disconnects the connection between the receiving terminal 1020 and the distribution station 1010. In other words, the operation that a receiving terminal 1020 participating in the multicast distribution disconnects the connection between the receiving terminal 1020 and the distribution station 1010 corresponds to notifying the distribution station 1010 that the storage of the content data has been completed. It is assumed here that the receiving terminal 1020 transmits a disconnection request to the distribution station 1010 when the connection is to be disconnected.

When the connection to all of receiving terminals 1020, to which content data are to be distributed by multicast, is disconnected and the disconnection has been detected, the distribution station 1010 has the beacon contain the reproduction instruction information, as already discussed above. The distribution station 1010 distributes beacons. This corresponds to notifying an instruction by which to start reproducing a content. As the receiving terminal 1020 acquires the reproduction instruction information by receiving the beacon, the receiving terminal 1020 starts reproducing the content data stored.

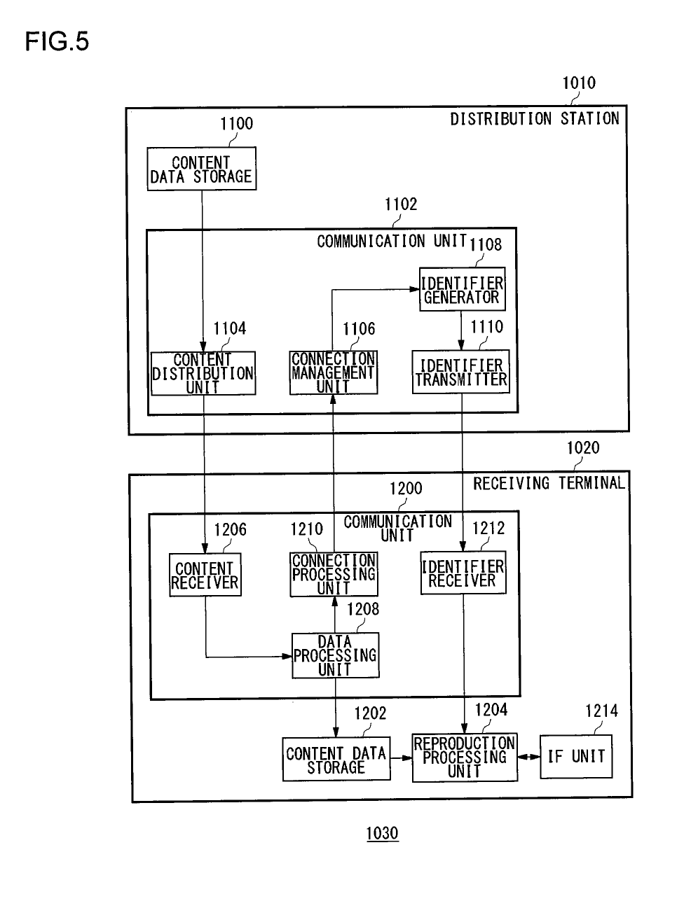

FIG. 5 illustrates a structure of the communication system 1030. The distribution station 1010 includes a content data storage 1100 and a communication unit 1102. The communication unit 1102 includes a content distribution unit 1104, an identifier generator 1108, an identifier transmitter 1110, and a connection management unit 1106. The receiving terminal 1020 includes a communication unit 1200, a content data storage 1202, and a reproduction processing unit 1204, an IF unit 1214. The communication unit 1200 includes a content receiver 1206, a data processing unit 1208, an identifier receiver 1212, and a connection processing unit 1210.

The content data storage 1100 stores content data which are to be distributed from the distribution station 1010. Content IDs used to identify the content data and packet numbers assigned to their packets of the content data are contained in the content data. The content distribution unit 1104 reads out the content data stored in the content data storage 1100. The content distribution unit 1104 distributes the read content data by multicast. It is assumed herein that the connection has been established between the distribution station 1010 and the receiving terminal 1020 and the multicast distribution has already been set.

The connection management unit 1106 performs processing for establishing and disconnecting connection with the receiving terminal 1020. When the connection to all of receiving terminals 1020 which receive the content data distributed from the content distribution unit 1104 is disconnected and the disconnection has been detected, the connection management unit 1106 requests the identifier generator 1108 to generate the reproduction instruction information used to instruct the start of the reproduction of said content data. Here, as described above, the receiving terminal 1020 is so designed and regulated as to reproduce the content data after the content data has been stored. And when the receiving terminal 1020 goes into a state where the content data become reproducible, namely a state where the distribution of content data has been completed, the receiving terminal 1020 disconnects the connection. By detecting a disconnection from the receiving terminal 1020 after the content data have been transmitted, the connection management unit 1106 determines that this receiving terminal 1020 is capable of reproducing the content data. The timing when the storage of content data has been completed in a plurality of receiving terminals 1020 is said to be the completion timing when the distribution of the content data has been completed.

The identifier generator 1108 generates reproduction instruction information that contains a reproduction-start instruction, based on a request from the connection management unit 1106. The reproduction instruction information is an identifier used to convey the start of content reproduction to the receiving terminal 1020 and is set separately from an identifier used to establish connection with the distribution station 1010 (hereinafter this identifier will be referred to as “connecting identifier”). The reproduction instruction information contains a content ID and information on time when the reproduction of the content is to start. Note that the network time protocol (NTP) is used as a protocol for adjusting the clock in the communication system 1030 and the reproduction start time is synchronized among a plurality of receiving terminals 1020. Note that the identifier generator 1108 may have the connecting identifier contain the stream IDs used to identify streams and a reproduction start instruction on each stream if the distribution station 1010 performs a plurality of multicast distributions. The identifier generator 1108 outputs the thus generated reproduction instruction information to the identifier transmitter 1110.

The identifier transmitter 1110 transmits the reproduction instruction information generated by the identifier generator 1108, as beacon. Note that the identifier transmitter 1110 may also transmit the connecting identifier which has been set separately from the reproduction instruction information. That is, when it is determined that the receiving terminal 1020 is capable of reproducing the content data, the identifier transmitter 1110 transmits a reproduction instruction on said content data.

The content receiver 1206 receives content data distributed by multicast from the distribution station 1010. The content receiver 1206 outputs the received content data to the data processing unit 1208. The data processing unit 1208 processes the content data received by the content receiver 1206. More specifically, if no content data stored in the content data storage 1202 bears the same content ID and packet number as those of the received content data, the data processing unit 1208 will have the content data storage 1202 store the received content data. If it is determined that content data stored in the content data storage 1202 has a preset ratio or more of data on said content data, the data processing unit 1208 will request the connection processing unit 1210 to disconnect the connection to the distribution station 1010. That is, the data processing unit 1208 determines whether or not the amount of content data stored in the content data storage 1202 is greater than or equal to a preset level defined as a reproducible amount.

The content data storage 1202 stores the content data received by the content receiver 1206. The content data stored therein is referenced by the reproduction processing unit 1204 described later. When it is determined by the data processing unit 1208 that the amount of content data stored in the content data storage 1202 is greater than or equal to the preset level, the connection processing unit 1210 disconnects the connection to the distribution station 1010. In this case, the connection processing unit 1210 transmits a disconnection request to the distribution station 1010.

The identifier receiver 1212 receives the reproduction instruction information distributed from the distribution station 1010, and extracts a reproduction start instruction contained in the reproduction instruction information. The identifier receiver 1212 requests the reproduction processing unit 1204 to start reproducing the content data according to the thus extracted reproduction start instruction. That is, after the content data have been stored in the content data storage 1202, namely after the connection has been disconnected by the connection processing unit 1210, the identifier receiver 1212 receives reproduction instructions on content data distributed from the distribution station 1010. The reproduction processing unit 1204 reproduces the content data acquired from the content data storage 1202, according to the instruction on reproduction start transmitted from the identifier receiver 1212. The IF unit 1214 is an interface with a user and is constituted by buttons, a display, a speaker and so forth. The display displays images out of the content data reproduced by the reproduction processing unit 1204. The speaker outputs audio out of the content data reproduced by the reproduction processing unit 1204. The buttons receive instructions from the user.

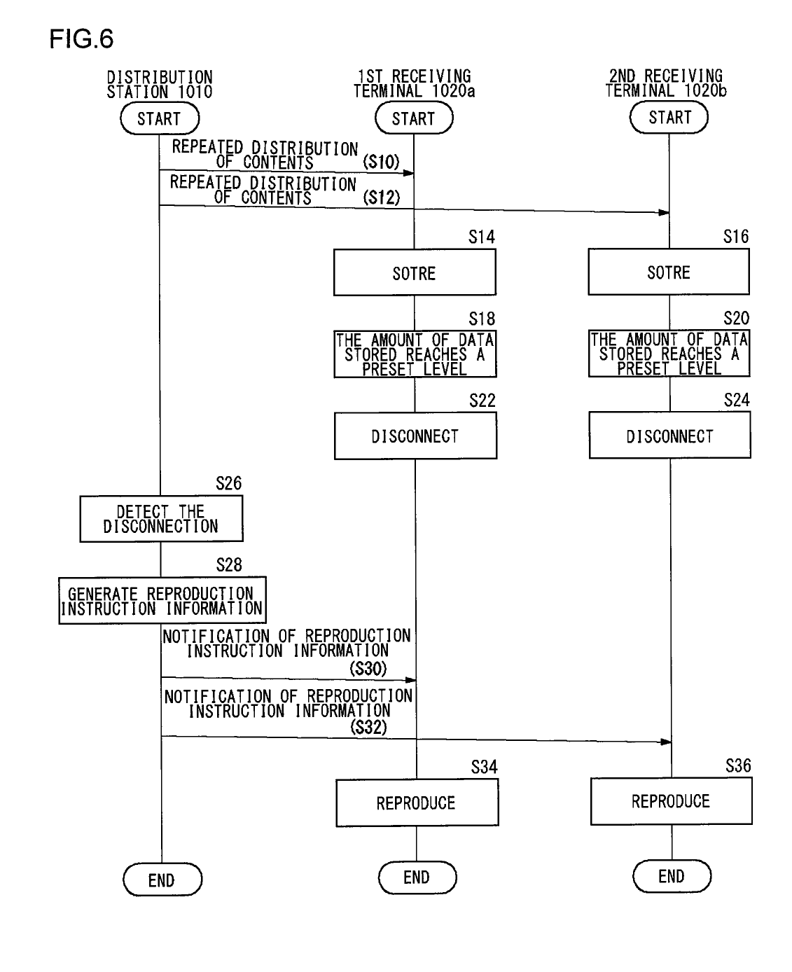

An operation of the communication system 1030 as structured above will now be described briefly. FIG. 6 is a sequence diagram showing a distribution procedure performed by the communication system 1030. The distribution station 1010 distributes content data repeatedly (S10, S12). The first receiving terminal 1020a stores content data (S14). When it is determined that the content data stored therein has reached a preset level (S18), the first receiving terminal 1020a disconnects the connection to the distribution station 1010 (S22). Similarly, the second receiving terminal 1020b stores content data (S16); and when it is determined that the content data stored therein has reached a preset level (S20), the second receiving terminal 1020b disconnects the connection to the distribution station 1010 (S24). As the distribution station 1010 detects the disconnection (S26), the distribution station 1010 generates reproduction instruction information (S28). The distribution station 1010 dispatches the reproduction information (S30, S32). The first receiving terminal 1020a reproduces the content data (S34), and the second receiving terminal 1020b also reproduces the content data (S36).

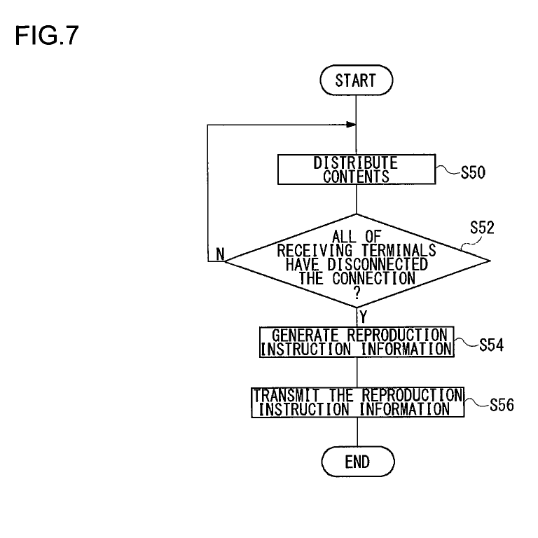

FIG. 7 is a flowchart showing a distribution procedure performed by the distribution station 1010. The content distribution unit 1104 distributes content data (S50). The connection management unit 1106 determines whether all of receiving terminals 1020, which had received said content data, have disconnected the connections or not (S52). If not disconnected (N of S52), a return will be made to Step S50 and the distribution of contents will continue until all of receiving terminals 1020 disconnect the connections. If it is determined that all of receiving terminals 1020 have disconnected the connections (Y of S52), the identifier generator 1108 will generate reproduction instruction information containing content reproduction start instructions (S54) and the identifier transmitter 1110 will transmit the thus generated reproduction instruction information as beacon (S56).

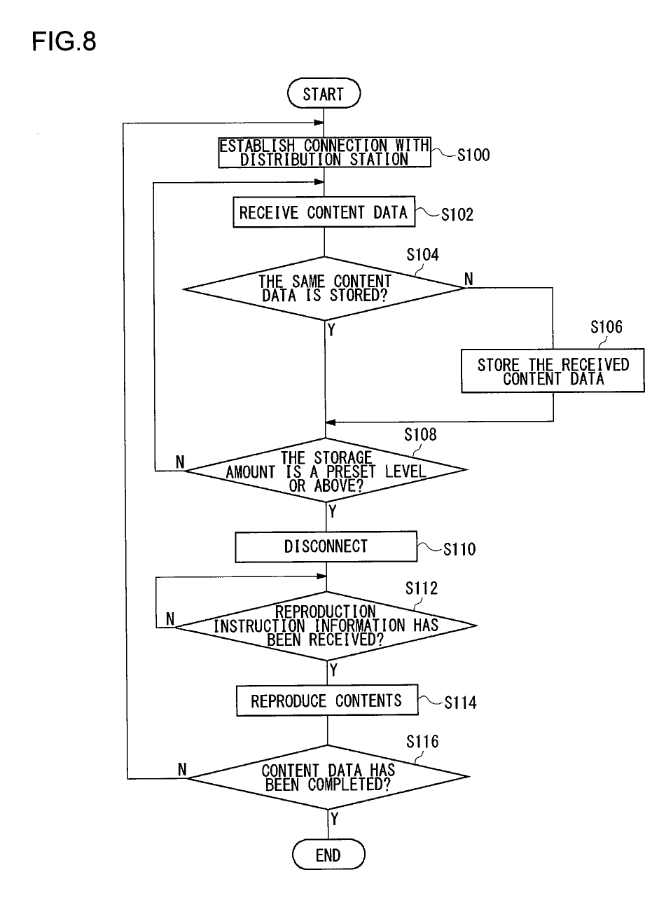

FIG. 8 is a flowchart showing a reproduction procedure performed by the receiving terminal 1020. The receiving terminal 1020 establishes connection between the receiving terminal 1020 and the distribution station 1010 (S100). The content receiver 1206 receives the content data distributed from the distribution station 1010 (S102). The data processing unit 1208 checks to see if any content data having the same ID and packet number with those of the received content data are stored in the content data storage 1202 or not (S104). If not stored (N of S104), the data processing unit 1208 will have the content data storage 1202 store the received content data (S106). If, on the other hand, the same content data are stored in the content data storage 1202 (Y of S104), Step S106 will be skipped. The data processing unit 1208 determines if the amount of content data stored in the content data storage 1202 becomes greater than or equal to a preset level or not (S108). If the amount of the content data stored is not the preset level or above (N of S108), return to Step S102. If, on the other hand, the amount of the content data stored is the preset level or above (Y of S108), the connection processing unit 1210 will disconnect the connection to the distribution station 1010 (S110). If the reproduction instruction information transmitted as beacon is not received (N of S112), wait ready until the beacon is received. When the reproduction instruction information is received (Y of S112), the reproduction processing unit 1204 reproduces the content data according to the reproduction start instruction contained in the reproduction instruction information received (S114). If the receiving of the content data has not been completed (N of S116), return to Step S100. If the receiving of the content data has been completed (Y of S116), the processing will be terminated.

According to this modification, after the content data have been received and then an instruction on the reproduction start has been received, the reproduction starts. Thus, even if the contents are to be distributed to a plurality of receiving terminals by multicast, the timings at which the respective receiving terminals start reproducing the content data can be synchronized. The connection to the distribution station is disconnected when the content data have been stored up to the reproducible level, so that the completion of storage of the content data can be notified without fail. Since stored are the repeatedly distributed content data, the quality of the content data can be enhanced. Also, after the content data have been repeatedly distributed, the instruction on the reproduction start is distributed only if it is detected that all of receiving terminals are capable of reproducing the content data. Hence, the reproduction start timing at each receiving terminal can be synchronized.

The present invention has been described based upon illustrative embodiment and modification. The exemplary embodiment and modification are intended to be illustrative only and it will be obvious to those skilled in the art that various other modifications to constituting elements and processes could be developed and that such modifications variations are also within the scope of the present invention.

In the exemplary embodiment of the present invention, the content data storage 202 stores the content data received from the content data management unit 216. However, this should not be considered as limiting and, for example, the content data storage 202 may delete the content data based on a predetermined rule. The predetermined rule may be, for example, “the content data which have not been referenced for a certain period of time are deleted”, “the content data are deleted according to instructions from the distribution station 10” and so forth. By employing this modification, the data amount of content data stored in the content data storage 202 can be reduced.

In the modification to the exemplary embodiment, the receiving terminal 1020 notifies the distribution station 1010 that the disconnection has made the reproduction executable. However, this should not be considered as limiting and the receiving terminal 1020 may notify the distribution station 1010 accordingly using other methods. The data processing unit 1208 determines whether or not the data amount of content data stored in the content data storage 1202 is greater than or equal to a preset level. Here, the preset level is defined as the amount of content data reproducible by the reproduction processing unit 1204. When it has been determined by the data processing unit 1208 that the amount of content data stored in the content data storage 1202 is the preset level or above, the connection processing unit 1210 notifies the distribution station 1010 accordingly. After the notification has been made by the connection processing unit 1210, the identifier receiver 1212 receives the reproduction instruction information. According to the present modification, a notification that the data amount of content data stored therein is the preset level or above is given, so that the timing of reproduction start can be determined.

In the present modification, the distribution station 1010 distributes content data using a multicast scheme. However, this should not be considered as limiting and, for example, the distribution station 1010 may have each receiving terminal 1020 download the content data therefrom and notify each of them about the instruction on the reproduction start using the reproduction instruction information when all of the receiving terminals 1020 have completed the downloading. Note that the completion of the downloading is notified similarly to the completion of storage in the modification. According to the present modification, the content data can be reliably transmitted to the receiving terminals 20.

The features and characteristics of the present invention described in the exemplary embodiments may be defined by the following Item 1 to Item 5:

Item 1:

A receiving apparatus comprising:

a first receiver which receives content data distributed repeatedly from a distribution apparatus;

a storage which stores updated content data in such a manner that the content data received by the first receiver are combined with content data received already and the content data are updated;

a reproduction unit which sequentially reproduces parts of the content data stored in the storage corresponding to content data received by the first receiver;

a monitoring unit which monitors a degree of completion of the content data stored in the storage;

a connection processing unit which disconnects a connection to the distribution apparatus when the degree of completion monitored by the monitoring unit becomes a preset level or above;

a second receiver which receives reproduction information, broadcasted from the distribution apparatus, indicating a part of the content data to be reproduced, after the connection has been disconnected by the connection processing unit,

wherein after the connection to the distribution apparatus has been disconnected, the reproduction unit reproduces the content data stored in the storage, according to the reproduction information received by the second receiver.

Item 2:

A receiving apparatus according to Item 1, wherein when reproducing the content data stored in the storage, according to the reproduction information received by the second receiver, after the connection to the distribution apparatus has been disconnected, the reproduction unit instructs the connection processing unit to establish connection with the distribution apparatus when the content data to be reproduced are not stored in the storage,

wherein the connection processing unit establishes the connection with the distribution apparatus, and

wherein after the connection to the distribution apparatus has been established by the connection processing unit, the first receiver receives again the content data distributed repeatedly from the distribution apparatus.

Item 3:

A distribution apparatus comprising:

a first transmitter which distributes repeatedly content data to a receiving apparatus;

a generator which generates reproduction information indicating a part of the content data to be reproduced by the receiving apparatus, based on a part of the content data distributed by the first transmitter; and

a second transmitter which transmits the reproduction information generated by the generator.

Item 4:

A receiving method comprising:

receiving content data distributed repeatedly from a distribution apparatus;

updating the content data by combining the received content data with content data received already and storing the updated content data in a memory;

reproducing sequentially parts of the content data stored in the memory corresponding to content data received in the receiving;

monitoring a degree of completion of the content data stored in the memory;

disconnecting connection to the distribution apparatus when the monitored degree of completion becomes a preset level or above;

receiving reproduction information, broadcasted from the distribution apparatus, indicating a part of the content data to be reproduced, after the connection has been disconnected,

wherein after the connection to the distribution apparatus has been disconnected, the reproducing reproduces the content data stored in the memory, according to the received reproduction information.

Item 5:

A distribution method comprising:

distributing repeatedly content data to a receiving apparatus;

generating reproduction information indicating a part of the content data to be reproduced by the receiving apparatus, based on a part of the content data distributed; and

broadcasting the generated reproduction information.

The features and characteristics of the present invention described in the modifications may be defined by the following Item 1 to Item 7:

Item 1:

A receiving apparatus comprising:

a first receiver which receives content data distributed from a distribution apparatus;

a storage which stores the content data received by the first receiver;

a second receiver which receives a reproduction instruction for the content data, transmitted from the distribution apparatus after the content data have been stored in the storage; and

a reproduction unit which reproduces the content data stored in the storage, according to the reproduction instruction received by the second receiver.

Item 2:

A receiving apparatus according to Item 1, further comprising:

a determining unit which determines whether or not the amount of the content data stored in the storage is greater than or equal to a preset level defined as an amount reproducible by the reproduction unit; and

a connection processing unit which disconnects connection to the distribution apparatus when it is determined by the determining unit that the amount of the content data stored in the storage is greater than or equal to the preset level,

wherein after the connection has been disconnected by the connection processing unit, the second receiving unit receives the reproduction instruction.

Item 3:

A receiving apparatus according to Item 1, further comprising:

a determining unit which determines whether or not the amount of the content data stored in the storage is greater than or equal to a preset level defined as an amount reproducible by the reproduction unit; and

a notifying unit which notifies the distribution apparatus that the amount of the content data stored in the storage is greater than or equal to the preset level when it is determined by the determining unit that the amount thereof is greater than or equal to the preset level,

wherein after the notification has been made by the notifying unit, the second receiving unit receives the reproduction instruction.

Item 4:

A distribution apparatus comprising:

a first transmitter which transmits content data to a receiving apparatus;

a determining unit determines whether or not the receiving apparatus is capable of reproducing the content data wherein the receiving apparatus, which receives the content data transmitted from the first transmitter, stores the content data; and

a second transmitter which transmits a reproduction instruction for the content data when it is determined by the determining unit that the receiving terminal is capable of reproduction the content data.

Item 5:

A distribution apparatus according to Item 4, wherein when connection is disconnected by the receiving apparatus after the content data have been transmitted from the first transmitter, the determining unit determines that the receiving apparatus is capable of reproducing the content data.

Item 6:

A receiving method comprising:

receiving content data distributed from a distribution apparatus; storing the received content data in a memory; receiving a reproduction instruction for the content data, transmitted from the distribution apparatus after the content data have been stored in the memory; and

reproducing the content data stored in the memory, according to the received reproduction instruction.

Item 7:

A distribution method comprising:

transmitting content data to a receiving apparatus; determining whether or not the receiving apparatus is capable of reproducing the content data wherein the receiving apparatus, which receives the content data, stores the content data; and

transmitting a reproduction instruction for the content data when it is determined that the receiving terminal is capable of reproducing the content data.

What is claimed is:

1. A distribution apparatus, comprising:
a first transmitter which distributes repeatedly content data to a first receiving apparatus; and
a second transmitter which broadcasts reproduction information for the content data distributed by said first transmitter wherein the reproduction information indicates a part of the content data to be reproduced by a second receiving apparatus.

2. A distribution apparatus according to claim 1, further comprising a generator which generates the reproduction information in such a manner as to be adjusted to the content data distributed from said first transmitter,
wherein said second transmitter broadcasts the reproduction information generated by said generator.

3. A distribution apparatus according to claim 1, wherein said first transmitter causes the first receiving apparatus to reproduce the content data distributed repeatedly, and
wherein said second transmitter causes the second receiving apparatus, which stores the content data, to reproduce the content data based on the reproduction information.

4. A distribution apparatus according to claim 1, wherein said first transmitter additionally distributes the content data to the second receiving apparatus, in response to a request from the second receiving apparatus.

5. A distribution apparatus according to claim 1, wherein said first transmitter causes the first receiving apparatus to store the content data.

6. A receiving apparatus, comprising:
a first receiver which receives content data distributed repeatedly from a distribution apparatus according to claim 1;
a storage which stores the content data received by said first receiver;
a second receiver which receives reproduction information, broadcasted from the distribution apparatus, indicating a part of the content data to be reproduced; and
a reproduction unit which reproduces the content data when the content data are received by said first receiver or which reproduces the content data stored in said storage according to the reproduction information received by said second receiver when the content data are not received by said first receiver.

7. A distribution apparatus, comprising:
a first transmitter which distributes content data to a plurality of receiving apparatuses; and
a second transmitter which transmits a reproduction instruction for the content data after the content data have been distributed from said first transmitter.

8. A distribution apparatus according to claim 7, further comprising a determining unit which determines completion timing at which said first transmitter completes the distribution of the content data,
wherein when said determining unit determines the completion timing, said second transmitter transmits a reproduction instruction.

9. A distribution apparatus according to claim 8, wherein a plurality of receiving apparatuses, which receive the content data transmitted from said first transmitter, store the content data, and
wherein said determining unit determined whether the plurality of receiving apparatuses are capable of reproducing the content data or not as the completion timing.

10. A distribution apparatus according to claim 9, wherein when connections are disconnected by the plurality of receiving apparatuses after the content data have been transmitted from said first transmitter, said determining unit determines that the plurality of receiving apparatuses are capable of reproducing the content data.

11. A receiving apparatus, comprising:
a first receiver which receives content data from a distribution apparatus according to claim 7;
a second receiver which receives the reproduction instruction for the content data transmitted from the distribution apparatus; and
a reproduction unit which reproduces the content data received by said first receiver according to the reproduction instruction received by said second receiver.
